(19) United States
(12) Patent Application Publication
(10) Pub. No.: US 2013/0173383 A1
(43) Pub. Date: Jul. 4, 2013

(54) Method Of, And System For, Authenticating And Custom Marketing Products In Response To Their Authentication

(71) Applicants: Satya Prakash SHARMA, East Setauket, NY (US); Jerome Swartz, Lloyd Harbor, NY (US)

(72) Inventors: Satya Prakash SHARMA, East Setauket, NY (US); Jerome Swartz, Lloyd Harbor, NY (US)

(73) Assignee: Zortag Inc., Great Neck, NY (US)

(21) Appl. No.: 13/342,433

(22) Filed: Jan. 3, 2012

(51) Int. Cl. G06Q 30/02

(52) U.S. Cl. 705/14.47

(57) ABSTRACT

Authentication information and product identification information associated with a product are captured by a portable interrogation device held and operated by a user. An authentication server determines from the captured authentication information whether the product is genuine or counterfeit. In response to the authentication, a marketing server identifies the product from the captured product identification information, and sends customized transactional information about the product to the device.

### FIELD OF THE DISCLOSURE

The present disclosure relates generally to a method of, and a system for, authenticating and custom marketing products in response to their authentication and, more particularly, to sending personalized marketing information, such as promotional offers, to consumers who are verifying whether the products are genuine or counterfeit.

### BACKGROUND

Capturing customers of products offered for sale by advertising through various media is a key marketing activity of every business or company competing in the marketplace. Television, newspapers, and most online advertising, however, generally advertise unsolicited products to the public at large. Since many consumers make most of their decisions about what products to buy at a point-of-sale at a retail site away from their televisions, newspapers and desktop computers, the companies supplying such products, as represented by their brand or product managers, have an increased interest in more targeted, time-sensitive, localized and personalized advertising, as well as in gathering as much information as possible about consumer behavior.

The Internet has opened new avenues, such as market places, contextual searches, comparison shopping, or other paid placements, for marketing products. Companies may buy some product keywords from an Internet search engine provider and, depending upon the consideration paid by the companies, the search engine provider will rank the companies and their products in a ranked list. When a consumer launches the search engine, the ranked list leads the consumer to obtain information for a product purchase. However, selecting and buying keywords and determining the amount of consideration is a guessing game for the companies. There is no certain relationship as to whether a consumer's selection, e.g., “click”, on a company's web site leads to any sale. The return on the advertising expenses incurred through an Internet search engine is, therefore, not readily calculable, at least not with any accuracy.

Sometimes, consumers buy products from an Internet site and provide the company with their contact information, such as their mobile phone numbers, their email addresses, and other personal information. Companies, then, often use this information to push their future product promotions to all individuals in their contact database whether or not an individual consumer is interested in any individual product. Again, this unsolicited promotion may does not necessarily result in readily calculable sales and, in some cases, may even deter sales if the consumer becomes annoyed with multiple and unsolicited promotions.

Targeting interested consumers and measuring the impact of any marketing and advertising campaigns are important for every enterprise, especially in the field of mobile marketing where cell phones, smart phones, personal digital assistants (PDAs), tablets, and like personal and always-on devices, that utilize text and/or audio and/or video, are employed. To control cost, advertisers typically limit the number of all possible individuals having mobile devices, either by randomly selecting individuals, or by using previously compiled profile information. Random selection is ineffective, and a marketing campaign based on profile information may also not be effective if the target audience is poorly selected. In any case, these are indirect means to select audiences and do not identify and target each individual who is truly interested in buying a specific product. Present methods of marketing are, therefore, ineffective, hit-or-miss propositions, and it is difficult to measure the return on the advertising investment, most of which is unfortunately wasted.

It is also difficult for average consumers to distinguish between authentic and counterfeit products, because their outside appearances look the same. Counterfeiting impacts virtually all products worldwide, with concomitant dwindling public trust in product and transaction authenticity. Early anti-counterfeiting techniques typically relied on tags or labels that were affixed to products. For example, one- and two-dimensional bar code symbols were printed on such labels, and were read by specialized electro-optical readers for product identification. Radio frequency identification (RFID) tags were affixed to the products, and were interrogated by specialized RFID readers. Magnetic stripes and holograms were affixed to credit, debit and identification cards, and were also read by specialized card readers. Subsequent anti-counterfeiting techniques typically employed physically unclonable functions (PUF) that exploited the physical properties of disordered structures, i.e., microstructures characterized by an explicitly-introduced randomness or an intrinsic randomness. Other anti-counterfeiting techniques included biometrics, such as fingerprints or iris scans, color-shifting inks, magnetic inks, molecular markers using microtaggants, tagging powder, DNA markers, or molecular finger prints, etc. Although generally satisfactory for their intended purpose, the known anti-counterfeiting techniques required specialized proprietary readers that worked in laboratory settings. Such readers were unavailable and unaffordable to consumers who wished to authenticate a product in the field, e.g., a consumer who wished to authenticate a retail product before purchase at a retail site.

Accordingly, there is a need for a method of, and a system for, authenticating products that can be quickly and reliably performed in the field by an average consumer without any special skill set, and without resort to specialized readers, and which authentication cannot be readily copied, duplicated or reverse-engineered, as well as a method of, and a system for, custom marketing such products in response to their authentication and, more particularly, to sending personalized marketing information, such as promotional offers, to consumers who are verifying whether the products are genuine or counterfeit.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a schematic overall diagram of a system for authenticating and custom marketing products in accordance with this invention;

FIG. 2 is a diagram of a part of the system of FIG. 1, showing details of a gateway server;

FIG. 3 is a diagram of another part of the system of FIG. 1, showing details of a marketing server;

FIG. 4 is a diagram of still another part of the system of FIG. 1, showing details of an authentication server;

FIG. 5 is a flow chart depicting steps in a method of authenticating and custom marketing products in accordance with this invention;

FIG. 6 is one database structure of the marketing server; and

FIG. 7 is another database structure of the marketing server.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The system elements and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

A method of authenticating and custom marketing a product, in accordance with one feature of this invention, comprises capturing authentication information and product identification information associated with the product with an interrogation device operated by a user, authenticating the product from the captured authentication information as being genuine or counterfeit, identifying the product from the captured product identification information, and sending transactional information about the identified product in response to the authentication.

Advantageously, the interrogation device is a portable handheld electronic device having a solid-state imaging module of the type universally found in consumer electronic digital cameras. The handheld device is typically a cellular telephone or smartphone that has a built-in imaging module, but can also be a personal digital assistant (PDA), a tablet, a computer, an e-reader, a media player, or like electronic device having a built-in imaging module, especially one that is normally readily at hand to the average user. The handheld device is aimed at the product, or a tag or label associated with the product, to capture return light from the product as an image. The image is processed to generate the captured authentication and product identification information. No special skill set is required for the user to capture the return light by simply taking a picture of the product or associated tag.

An exemplary method of, and system for, authenticating a product as being genuine or counterfeit, either before or after a purchase, by using the above-described image capture device was proposed in U.S. patent application Ser. No. 13/269,726, the entire contents of which are hereby incorporated herein by reference thereto. One feature of this invention is to use, and rely on, this act of authenticating the product as a marketing indication of whether a consumer is truly interested in buying, or perhaps, has already bought or received, a specific product. This marketing indication is a trigger for sending the transactional information, for example, promotional information or discount coupons, to the user of the device, and is an effective marketing tool in targeting the correct consumer with time-sensitive, localized and personalized advertising. This transactional information can vary depending upon whether the product is genuine or counterfeit.

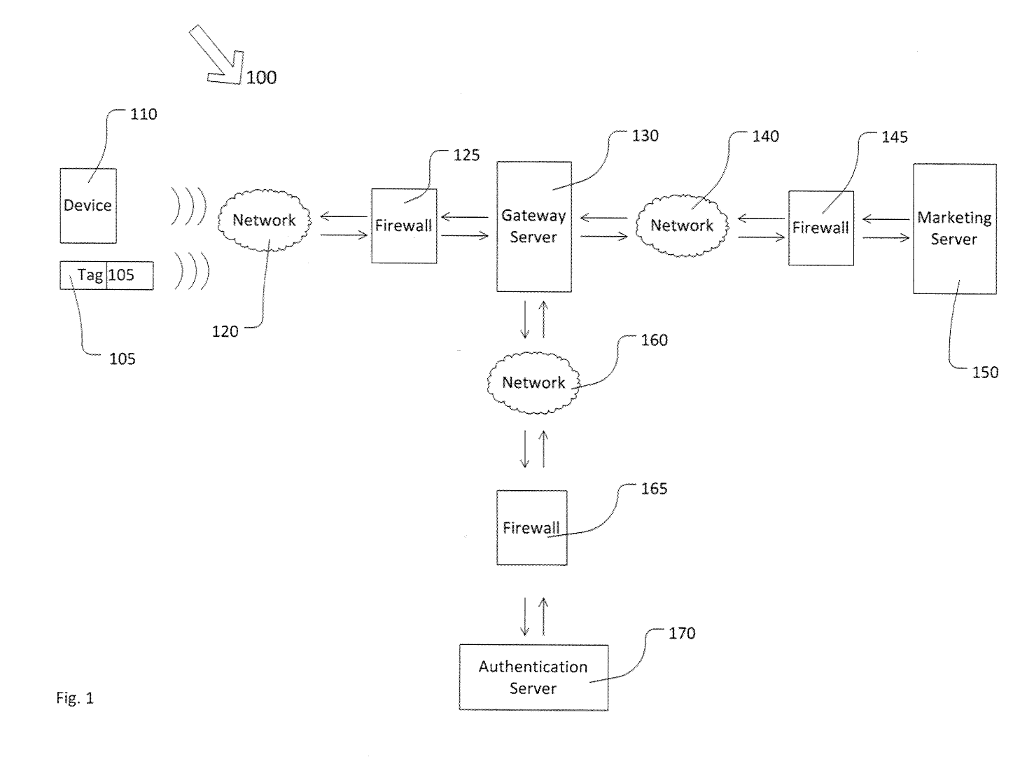

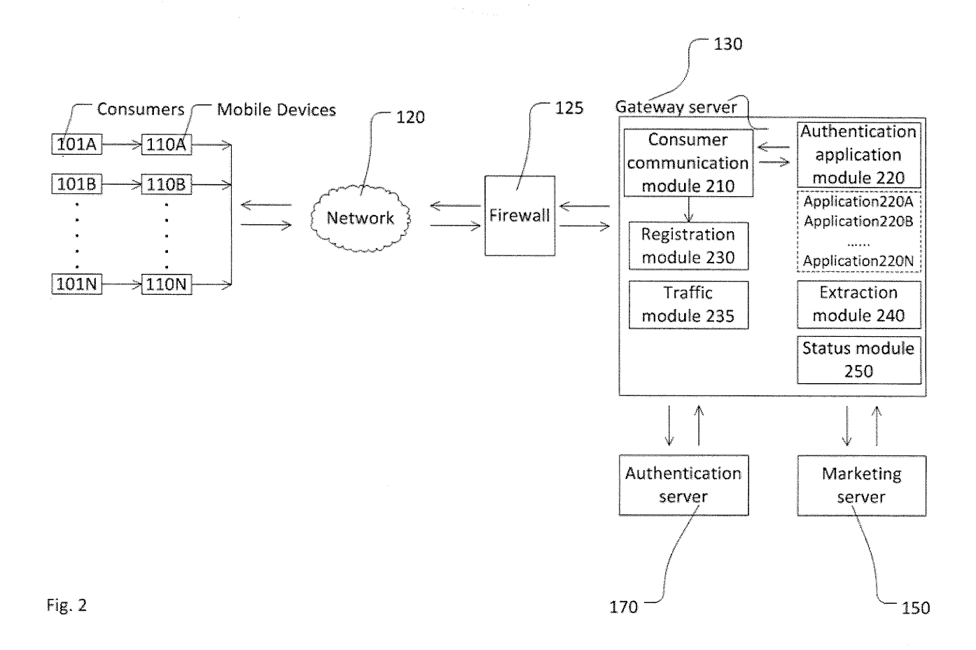

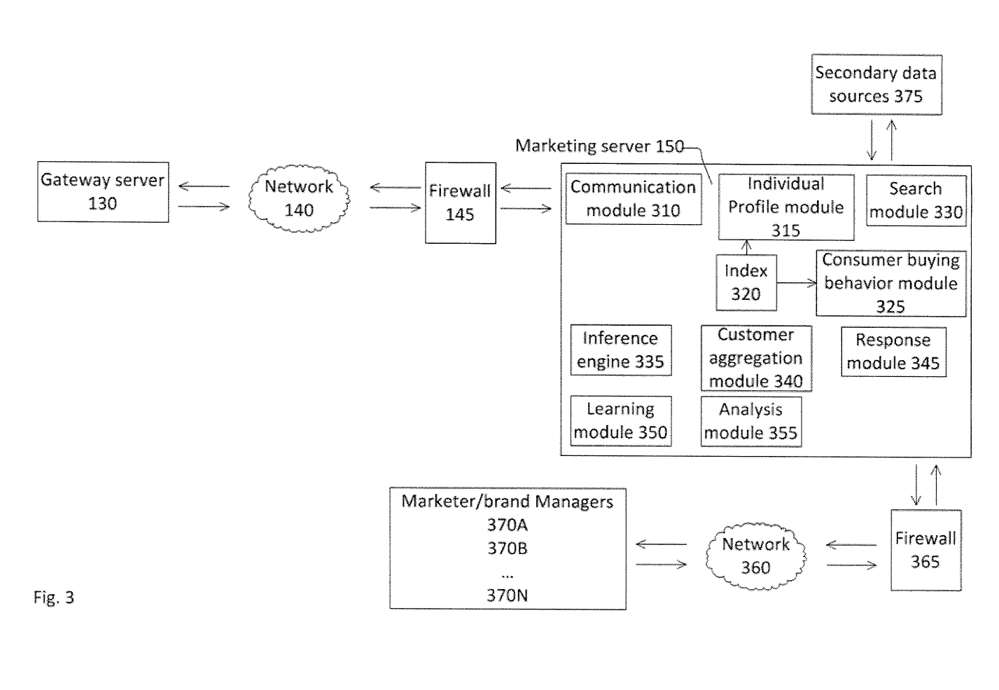

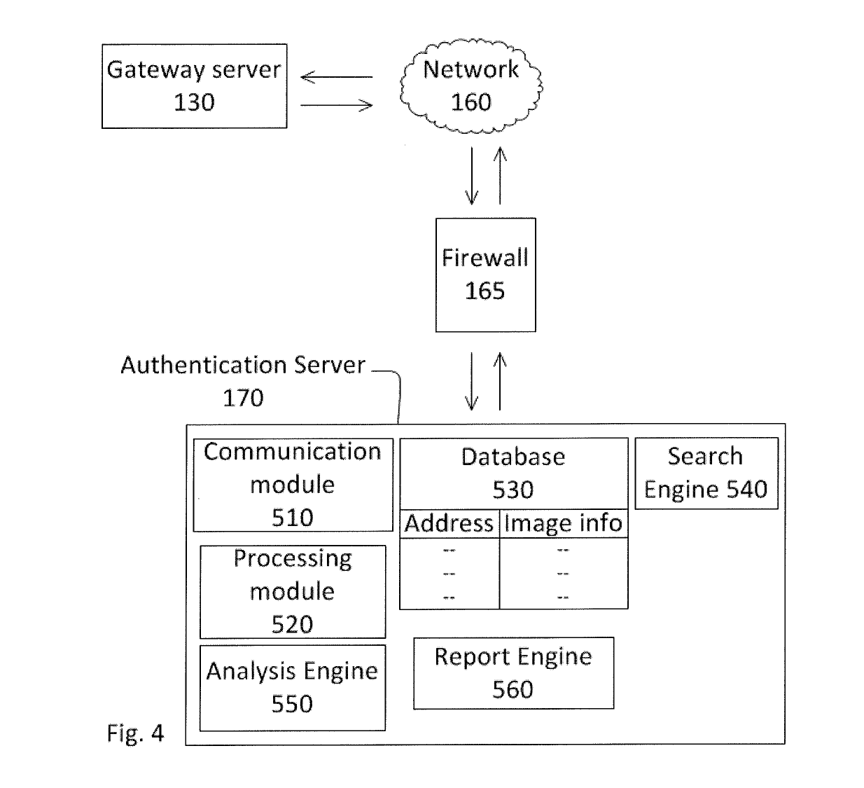

Turning now to the drawings, reference numeral 100 in FIG. 1 identifies a system for authenticating and custom marketing products in accordance with this invention. System 100 includes a portable, handheld, interrogation device 110, a gateway server 130 (FIG. 2), a marketing transaction server 150 (FIG. 3), and an authentication server 170 (FIG. 4). The device 110 is in bidirectional communication with the gateway server 130 via a wireless or wired network 120 and a firewall 125. The gateway server 130 is in bidirectional communication with the marketing server 150 via a network 140 and a firewall 145. The gateway server 130 is also in bidirectional communication with the authentication server 170 via a network 160 and a firewall 165. Although three servers have been illustrated, this is not intended to be limiting, because this invention contemplates that a different number of servers could be employed and, indeed, that the three servers 130, 150 and 170 could all be combined into a single master server.

The handheld device 110 is typically a cellular telephone, smartphone, or Internet Protocol or net phone, that has a built-in imaging module, but can also be a personal digital assistant (PDA), a tablet, a computer, an e-reader, a media player, or like mobile electronic device having a built-in imaging module and being capable of bidirectionally exchanging data and/or video and/or text over a packet-based or non-packet-based communications network. An exemplary image capture device is disclosed in U.S. patent application Ser. No. 13/269,726, whose disclosure is hereby incorporated herein by reference thereto. As described therein and as further detailed below, the device 110 captures return light from a product or a label or tag 105 associated with, or affixed to, the product, as an image. The image is processed to capture authentication information indicative of whether the product is genuine or counterfeit, as well as product identification information that identifies the product. The device 110 may communicate with the gateway server 130 in encrypted or unencrypted form, and in real or delayed time.

The network 120 may be any wired or optical network, or preferably any wireless cellular network, such as version 2G, 3G, or 4G, the Internet, or any other type of wireless network, such as an ad hoc wireless network, a mesh network, a free space optical network, a metro area network, a wireless local area network, Wi-Fi, etc. The network 120 may send and/or receive data through packet-based or non-packet-based exchanges. The networks 140 and 160 may include any wired, wireless, or optical network capable of bidirectionally transferring data and may include public switched telephone networks, local area networks, metropolitan area networks, wide area networks, the Internet, etc., and can use any network protocol, i.e., Internet Protocol (IP), Asynchronous Transfer Mode (ATM) or Synchronous Optical Network (SONET), etc. The networks 140 and 160 may also include network devices, such as routers, switches, firewalls, gateways, communication interfaces, input devices, output devices, and buses to interconnect such server components as processors, microprocessors, random access memories (RAMs), dynamic storage devices, read only memories (ROMs), etc.

As best shown in FIG. 2, the gateway server 130 includes hardware and software programmed to perform certain functions in response to software instructions contained in a computer readable medium. The gateway server 130 interacts with multiple consumers 101A, 101B, . . . 101N respectively holding multiple image capture devices 110A, 110B, . . . 110N and may register each device 110, and may run such applications as database applications, email applications, communication applications, and e-commerce applications.

The gateway server 130 includes a consumer communication module 210 for receiving a request from each consumer 101 and sending information back to each consumer's device 110. If the communication module 210 receives a request for downloading the application for authenticating products, then the communication module 210 fetches the appropriate application 220A, 220B, . . . 220N from an authentication application module 220 and transmits the fetched application to the consumer's device 110 for downloading. The fetched application resides in the consumer's device 110 and may be launched by actuating an icon displayed on the device. At the same time, the communication module 210 checks if the consumer's device 110 was previously registered in the system and, if not previously registered, the communication module 210 seeks registration information, for example, the ID or phone number of the device, and consumer profile information, for example, the consumer's email address, name, residence address, and other demographics, such as income, shopping habits, hobbies, and family details before the consumer is allowed to download the authentication application residing in the application module 220. A registration module 230 stores the device ID or cell phone number for future comparison when the consumer tries to authenticate another product he/she wants to buy or has bought. The registration module 230 transmits the profile information to a profile module 315 (see FIG. 3) in the marketing server 150. The registration module 230 only keeps the registration information about the mobile device ID, e.g., the cell phone number, but not the consumer's profile information.

As noted above, the information captured by the device 110 includes the captured authentication information and the captured product identification information. An extraction module 240 in the gateway server 130 separates and distinguishes the authentication information from the product identification information, e.g., the product code, the manufacturer code, and the country of origin of the product. The gateway server 130 also includes a traffic module 235 for directing the captured authentication information to the authentication server 170, and for directing the captured product identification information to the marketing server 150. When the gateway server 130 receives a request for authentication and the device 110 is already registered with the gateway server, then the gateway server 130 sends the captured authentication information needed to authenticate the product to the authentication server 170. Typically, the authentication information to be sent to the authentication server has two parts. One is an address identifier, e.g., a bar code or radio frequency identification (RFID) or other addressing means, and the other is an authentication pattern image such as described in the aforementioned incorporated U.S. patent application. The authentication server 170 has a database 530 (see FIG. 4) that has a pre-stored reference authentication information or signature that was affixed to each product at the point of manufacture, and includes both an address and an associated reference image or signature.

While authentication is performed in the authentication server 170, a status module 250 in the gateway server 130 sends the status of the authentication to the consumer 101 through the communication module 210. In certain situations, no address information is sent to the authentication server 170, and only the pattern image information is sent. The authentication server 170 searches the entire database 530 and locates the address that corresponds to that image. The consumer then provides additional information through the communication module 210 to the authentication server 170 that matches the address information, or the authentication server 170 sends the address information back to the consumer who can confirm that the address is right. This may take place, for example, in case of expensive paintings or items of high value that have been acquired by consumers, and where the address, e.g., a bar code, was not affixed to the product for esthetic purposes.

As best shown in FIG. 3, the marketing server 150 includes hardware and software programmed to perform certain functions in response to software instructions contained in a computer readable medium. A communication module 310 controls communication between the marketing server 150 and the gateway server 130, such as the delivery of the product identification information to the marketing server 150, as well as the delivery of the aforementioned individual customer profiles for storage in the individual profile module 315. An index module 320 indexes the individual customer profiles. A consumer buying behavior module 325 stores the buying behavior of the consumer. Secondary data sources 375 may also be used to supplement/complement the consumer behavior module 325. These secondary data sources 375 may include Internet-based electronic commerce, m-commerce, web browsing and third party data sources showing the buying behavior of the consumer. Communication with the secondary sources 375 may be through a network similar to networks 140, 160 or 120 or other electronic means (not shown here for brevity).

The marketing server 150 also includes a search engine module 330 for searching records in the buying behavior module 325 and the profile module 315 through keywords, a genre, a theme, a geographical location, etc. The search module 330, for example, can identify consumers in a geographic location who are looking to buy a particular product, e.g., a handbag, a shoe, a camera, etc. and who have already communicated with the gateway server 130 to authenticate that particular product before or after buying it. An inference engine 335 associates attributes of the particular authentic product with other products. For example, a consumer who bought an authentic handbag may also be interested in buying an authentic shoe or an authentic scarf. A consumer who buys an authentic camera may also be interested in buying an authentic computer. This inference may help a marketer, e.g., a brand or product manager, to influence the future buying behavior of a consumer.

The marketing server 150 also includes a customer aggregation module 340 for creating an aggregated database of consumers with similar buying behaviors. This information may be of great value to marketers/brand or product managers 370A, 370B, . . . 370N who interact with the marketing server 150 through another network 360 and a firewall 365. The network 360 could be a wireless, wired, optical, Internet, Intranet, virtual private network or any other network.

The communication from individual product managers 370A, 370B, . . . 370N to individual customers 101A, 101B, . . . 101N proceeds through the marketing server 150 by sending personalized marketing information, such as promotional offers, through the gateway server 130 in real or delayed time. When a consumer sends a request for authenticating a product to the authentication server 170 via the gateway server 130, the product identification information extracted by the extraction module 240 is sent to the marketing server 150, which updates the individual's buying behavior module 325, and is also sent to the product managers 370A, 370B, . . . 370N apprising them of the product being considered by the consumer. Each product manager 370 then generates the personalized offer, preferably a time-sensitive offer, in real or delayed time, and communicates with the consumer via the communication modules 210, 310.

By the time the product is authenticated, the consumer may also receive the advertising offer from the product manager. This offer may be a coupon code in the form of a bar code that is communicated to, and displayed on, the consumer device 110 in real time when the authentication information is communicated to the consumer, or an offer number, or some other promotion. The coupon bar code or customized offer may be time-bound and may expire after a predetermined time, as deemed appropriate by the product manager. When the coupon code is redeemed by the consumer, this information is sent back to the product manager, and this information is stored in a response module 345 in the marketing server 150. Thus, the product manager knows with accuracy just what the return on the advertising investment (ROI) is.

Based on the real time response to the offer on the device 110, statistical and other analysis can be performed by an analysis module 355 in the marketing server 150 to determine the effectiveness of the marketing campaign. A learning module 350 in the marketing server 150 can modify or suggest future improvements in the advertising campaign. For example, during certain times of the year, e.g., holidays, in a given country, special marketing campaigns on special items may be effective. The ROI on these campaigns on specific items can be measured by the analysis module 355, and the learning module 350 can suggest modifications or alternatives, especially in real time while special sales are going on.

As best shown in FIG. 4, the authentication server 170 includes hardware and software programmed to perform certain functions in response to software instructions contained in a computer readable medium. The authentication server 170 includes a communication module 510, a processing module 520, the aforementioned database 530, a search engine 540, an analysis engine 550, and a report engine 560. The authentication server hardware may include communication interfaces, input devices, output devices, and buses to interconnect the components of the authentication server, such as processors, microprocessors, RAMs, dynamic storage devices, ROMs, and other storage devices.

The communication module 510 sends and receives information to/from the gateway server 130. The received information from the gateway server 130 may contain an address location in the database 530 and pattern image information associated with that address location. The processing module 520 processes instructions related to the operation of the authentication server 170, and retrieves the stored reference image information in the database 530 at the address identified by the captured authentication information from the gateway server 130, and compares the stored reference image information in the database 530 with the captured authentication information received from the gateway server 130. If the captured authentication information received from the gateway server 130 matches all attributes of the stored reference image corresponding to the address location, then the processing module 520 sends an output to the device 110 via the gateway server 130 with a message such as “product authentic”, or a similar message. If there is no match, then the processing module 520 sends an output to the device 110 via the gateway server 130 with a message such as “unable to authenticate, try again”, or “counterfeit”, or a similar message.

The search engine 540 performs a reverse search where only the image pattern is available, but the address of the image is not known. The search engine 540 identifies the address of the image that can be communicated to the consumer device 110, where it can be tallied with other relevant information.

The analysis engine 550 analyzes the product types of manufacturers to determine which products are being counterfeited most, and in which geographic locations based on the device location and the demographic information in the consumer profile module 315. The analysis engine 550 collects, for each consumer device 110, such information as which products were authentic and which were not, and which locations and which brands were or were not authentic. The analysis engine 550 also aggregates the data by each brand/manufacturer and the product types of each brand for communicating to brand or product managers/marketers/manufacturers without providing any information about the consumer device, thereby protecting consumer privacy, and also flags the geographical locations/website where major counterfeit products are being detected. The analysis engine 550 may also include aggregate information about the products authenticated, styles, shapes, date of authentication, merchant names and locations etc. The analysis engine 550 also conducts data mining based on hardware or software logic.

The report engine 560 creates reports for each brand or product manager/marketer in the format specified by the manager based on the analysis by the analysis engine and communicates these reports through the communication module 510 to the gateway server 130, and finally to the marketers/brand or product managers through the marketing server 150 for their action.

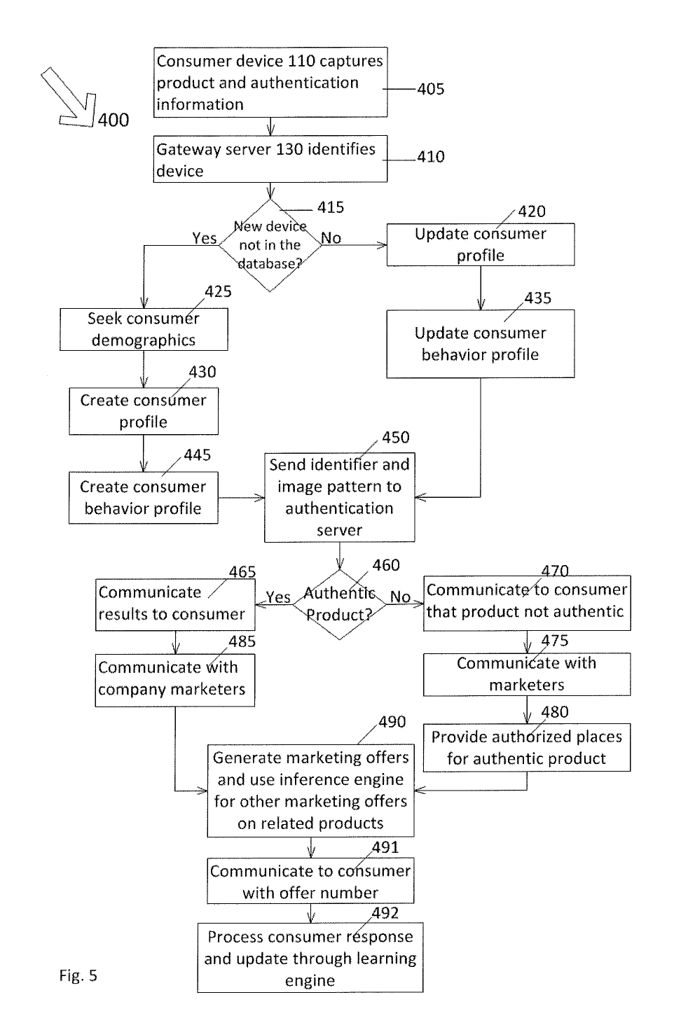

FIG. 5 is a flow chart 400 of an exemplary method of authenticating and custom marketing products in response to their authentication and, more particularly, to sending personalized marketing information, such as promotional offers, to consumers who are verifying whether the products are genuine or counterfeit. Typically, a consumer 101 has an icon displayed on his/her consumer device 110 that has been previously downloaded from an Internet website that allows the consumer through his/her consumer device 110 to scan or interrogate a product or tag 105 to capture authentication information and product identification information at step 405. The application icon can sit on the consumer device 110 and be clicked or otherwise activated by pressure, exerted by a finger or a stylus, on a touch screen, thereby triggering the authentication process. The authentication information and the product identification information are both affixed by the label or tag 105, or embedded into, or directly applied to, the product, and are captured, preferably simultaneously, by the device 110. The authentication information includes an image pattern and an image address identifier. The product identification information includes a product identifier and a brand name identifier. The device 110 may encrypt the captured information and forward the encrypted/unencrypted data to the gateway server 130.

At step 410, the gateway server 130 receives the captured authentication and product identification information and identifies the device 110. At step 415, the gateway server 130 checks to see if the device 110 is registered and is in the registration module 230. If it is not a new device, i.e., it is registered in the registration module 230, then the product identification information is extracted by the extraction module 240 at step 420, and sent to the marketing server 150 where it is used to update the consumer profile module 315 at step 420, and to update the behavior module 325 at step 435. If the consumer device 110 is new, i.e., it is not previously registered in the registration module 230, then consumer demographic information is requested at step 425, and the consumer will also be apprised of the prevailing privacy policy attached to such demographic information. The consumer will also be asked if he/she wants to receive any future marketing materials. The consumer may opt-in or opt-out at this step. If the consumer opts in, interaction with the gateway/marketing/authentication servers is continued. At step 430, the demographic information is used to create a consumer profile in the profile module 315 and, at step 445, a consumer buying behavior profile is created in the consumer buying behavior module 325.

At step 450, the authentication information is sent to the authentication server 170. At the time of manufacture, a reference image pattern or signature and an address of the reference image pattern is affixed to, or embedded in, the product or tag 105. This image pattern and the associated address is stored in the authentication server database 530. The processing module 520 compares the captured authentication information with the stored reference image at the corresponding stored address at step 460. If there is a match, then the product is deemed authentic, and the result is communicated to the device 110 in step 465, and is also sent to the marketers/brand or product managers in step 485, who then generate marketing offers to be communicated to the device 110 at step 490. The offer may have a specific offer number at step 491, and the response to the offer number is then measured in step 492 to calculate the ROI and the effectiveness of the marketing offer.

If there is no match, then the product is deemed counterfeit, and the consumer 101 is informed that the product that he/she plans to buy, or has bought, is not authentic, in step 470. The marketing server 150 also communicates with the brand or product managers/marketers that a consumer is looking at, or has bought, a product that is not authentic, in step 475. The marketers may request additional information from the marketing server 150 about the location of the counterfeit product, and also of the identity of the device and the merchant or website. If the consumer agrees to provide this information, it can also be communicated to the marketers/brand or product managers in step 475. At step 480, the brand or product managers/marketers may provide locations where an authentic product of their brand may be available in the vicinity of where the consumer device is. The brand or product manager/marketer may also send a marketing/advertising offer to consumers about authentic products at the step 490. The consumer offer may have a specific offer number at the step 491 and the response to the offer number is then measured in step 492 to calculate the ROI and the effectiveness of the marketing offer.

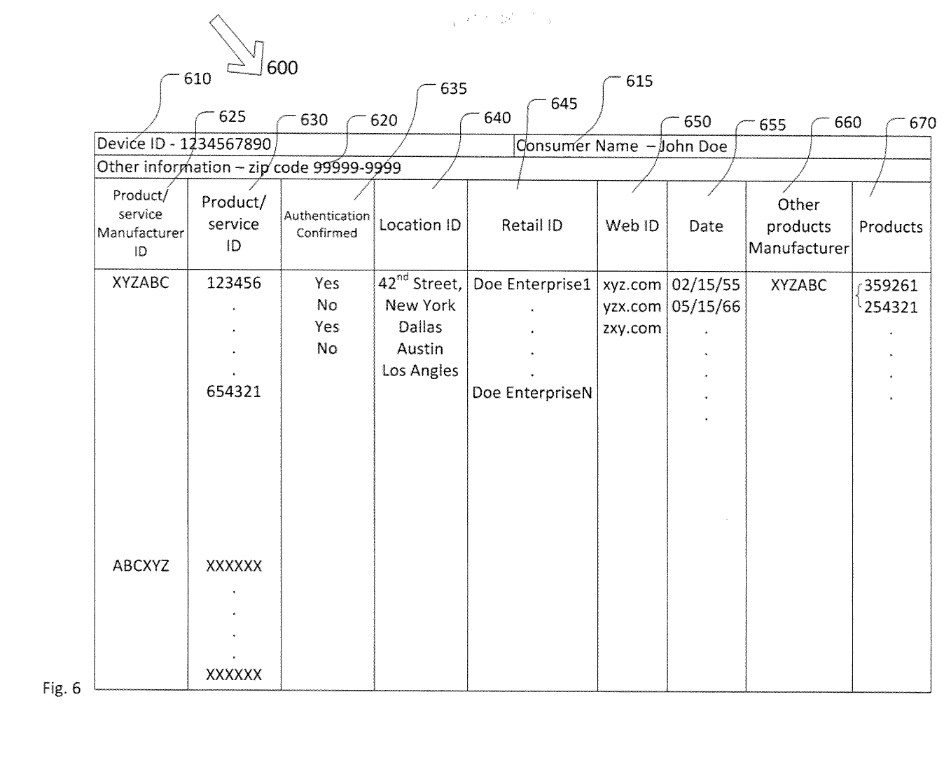

FIG. 6 illustrates an exemplary database structure 600 that stores data in the consumer buying behavior module 325 of the marketing server 150. Database structure 600 includes multiple fields arranged for easy data retrieval, such as device identification number field 610 and consumer name field 615 derived from the consumer profile module 315. Zip code information is stored in field 620, which may contain other pertinent information if needed to obtain further specificity about the device 110. Information about the brand or product manager/manufacturer/or service provider is included in field 625. The field 630 includes the product/service type of the brand. Information as to whether the product was authenticated when the consumer sent the authentication information to the authentication server 170 is included in field 635. The field 640 includes the location where the authentication attempt took place, and may include a specific address or just the city. A retail ID as shared by the consumer when a product is attempted for authentication is included in field 645. If the product was bought from a website, then the consumer may share the web ID information, which is stored in field 650. The field 655 shows the date when the product authentication was attempted. Any other manufacturer of an equivalent product or a brand similar to the product identified in field 625 is included in field 660, and the equivalent products are included in the field 670. Additional data fields can be included as needed. Structure 600 is only exemplary and is not all inclusive. The data as compiled in structure 600 is used by marketers/brand managers in creating marketing offers customized for each consumer and communicated to the consumer device 110 through the marketing server 150 and the gateway server 130.

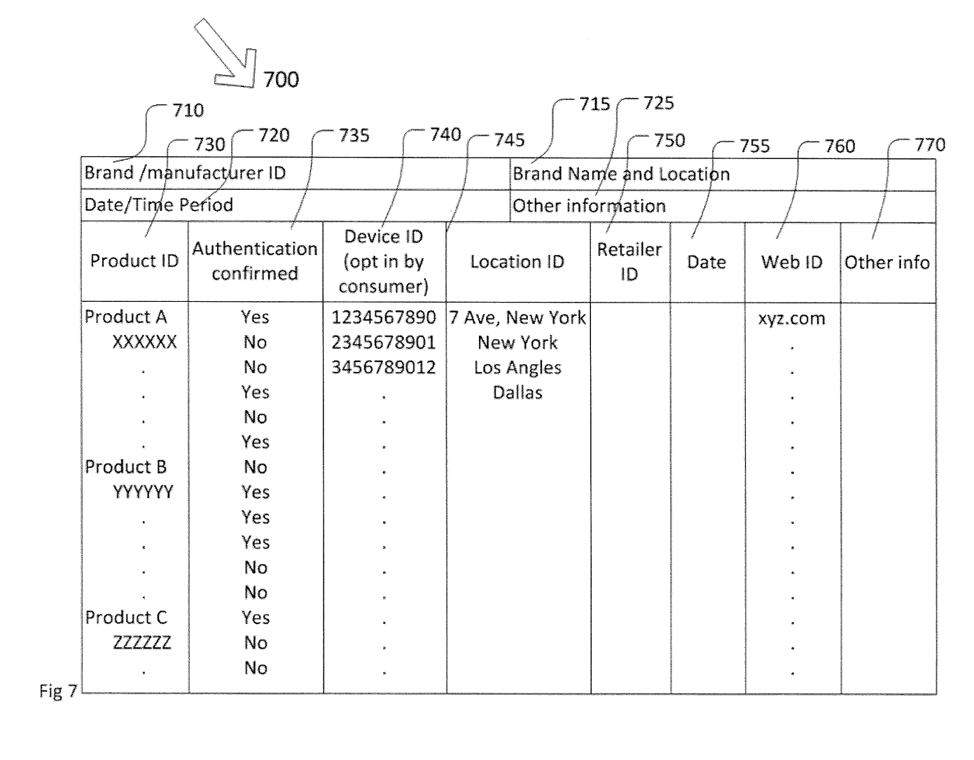

FIG. 7 describes an exemplary database structure 700 that collects and stores data related to each brand or product manager/manufacturer/marketer 370A, 370B, . . . 370N in multiple fields. The brand ID is included in field 710. The field 715 shows the brand name and the address location. The field 720 includes the time period for which the data has been collected for communicating to the marketers. Any other information regarding the brand may be included in field 725. The field 730 includes the product ID of the brand for which the information is collected. The field 735 shows whether or not the products were confirmed authentic by the authentication server 170 when the attempt for authentication was made by the consumer. The field 740 shows the consumer device ID if a consumer has opted in to share this information. The field 745 shows the locations for each product where the authentication attempt was made, and may include a specific address or the city. The field 750 shows the retailer ID, and the field 760 shows the web ID if the product was bought from an online merchant. The field 755 shows the date when the authentication attempt was made. Any other information may be included in the field 770. The database structure 700 is only exemplary and is not meant to be all inclusive. The information as compiled in the structure 700 is used to produce reports for each manufacturer/brand or product manager/marketer to know what percent of the products that are being sold in various geographic locations are authentic so that appropriate actions can be taken against offending merchants or websites.

In one embodiment, if the product is not authentic, then the marketer/brand or product manager may advise the consumer where authentic items are available near the consumer's location and, at the same time, may also send a time-bound offer, e.g., a coupon bar code, to the consumer's device through the communication module 310 and the communication module 210.

In another embodiment, the consumer may have already bought the product and may be authenticating the product after the purchase. The product could have been bought in a retail store, or via the Internet. If the product is authentic, then the marketer may send additional information on related products and/or the locations where authentic related products may be available in the immediate vicinity of the consumer, as well as a time-bound offer, e.g., a coupon bar code or other related promotional offer, on such other related products, to the consumer device. If these offers are redeemed, then the ROI can be measured on such related items; the advertising effectiveness can be measured; and the learning module 350 can provide frequent feedback to the marketer. If the product is not authentic, then the marketer may suggest where authentic products are available and/or also send a marketing offer to purchase an authentic product. The consumer may report the merchant or site where a fake product was bought from, and the manufacturer/marketer may decide to take an appropriate action. This is especially true if the product is harmful, e.g. a pharmaceutical product bought from a retail outfit or through an Internet website. The consumer may also report counterfeit products to federal agencies in addition to the marketer/manufacturer for proper action.

The analysis module 355 generates census information or reports of the percentage of the products that were not authentic in a given geographic location. The counterfeit products can be stratified by product type, by time, and by a specific merchant. A manufacturer/brand or product manager and law enforcement agencies can utilize such reports to gather additional information in those areas leading to prosecution to help law abiding manufacturers/brand managers.

One advantage of the present invention is that the privacy of individuals can be protected and not divulged to marketers unless the consumer specifically agrees to such disclosure. A marketer can communicate with individual consumers without knowing the identity of a consumer. Profiles of consumers change and their buying behavior may also be spontaneous. The marketing method of this invention can respond to consumers in real time.

In summary, when a person has decided to buy a product from a retailer, or has already bought a product from a merchant or through an Internet site, or has received a product as a gift, he/she may decide to authenticate whether or not such product is indeed authentic. In case the consumer is authenticating the product before buying, a brand or product manager may influence the buying decision of the consumer in real time through the portable handheld device 110. In case the customer has already bought or received the product and the product is not authentic, then the consumer may return the product to the merchant, and the brand or product manager may suggest places or authorized sites where their authentic product is available, and also offer a discount or credit in some form to the consumer. This invention relies on the consumer's action of trying to authenticate the product, either before or after purchase or receipt. The brand or product manager can influence, in real or non-real time, the consumer's behavior.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

For example, instead of authenticating a product, this invention can authenticate a credit/debit card when a consumer buys a product. A merchant's credit/debit card reader may capture both the credit/debit card number and an authentication pattern image embedded in the credit/debit card. The card numbers and the pattern image will go through the gateway server 130 to the authentication server 170 and, if the credit/debit card is fake, then this status is communicated to a card issuing agency. The card may be forfeited, and the card issuing agency knows where, when, and what location that the fake cards were presented. Similarly, if there is fake currency in circulation, and if a consumer tries to authenticate the fake currency, then any fake currency may be communicated to federal and law enforcement agencies for proper action. The invention covers these and all other similar applications where authentication is attempted of any article or object or service of any kind. Thus, the term “product” as used in the specification and the claims is intended to cover not only physical items, but also services.

The device 110 need not be an image capture device as described above, but could, in general, be any interrogation device, such as an RFID reader, or a magnetic stripe reader, a credit card reader, or a hologram reader, etc. The device 110 need not be based on optical principles as described above, but could be based on electrical, magnetic, electromagnetic, or electrooptic, magnetooptic, principles. Also, visible light need not be used, because ultraviolet and infrared light could also be employed. Characteristics other than reflection and scattering, such as absorption and fluoresence. could also be employed.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing,” or any other variation thereof, are intended to cover a non-exclusive inclusion, such that a process, method, article, or apparatus that comprises, has, includes, or contains a list of elements does not include only those elements, but may include other elements not expressly listed or inherent to such process, method, article, or apparatus. An element proceeded by “comprises . . . a,” “has . . . a,” “includes . . . a,” or “contains . . . a,” does not, without more constraints, preclude the existence of additional identical elements in the process, method, article, or apparatus that comprises, has, includes, or contains the element. The terms “a” and “an” are defined as one or more unless explicitly stated otherwise herein. The terms “substantially,” “essentially,” “approximately,” “about,” or any other version thereof, are defined as being close to as understood by one of ordinary skill in the art, and in one non-limiting embodiment the term is defined to be within 10%, in another embodiment within 5%, in another embodiment within 1%, and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors, and field programmable gate arrays (FPGAs), and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein, will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

We claim:

1. A method of authenticating and custom marketing a product, comprising:
capturing authentication information and product identification information associated with the product with an interrogation device operated by a user;
authenticating the product from the captured authentication information as being genuine or counterfeit;
identifying the product from the captured product identification information; and
sending transactional information about the identified product in response to the authenticating.

2. The method of claim 1, wherein the capturing is performed by holding and aiming the interrogation device at the information associated with the product by the user to capture return light from the product as an image, and by processing the image to generate the captured authentication information as an image pattern; and wherein the authenticating is performed by comparing the image pattern with a reference authentication signature, and by indicating that the product is genuine when the image pattern matches the reference authentication signature.

3. The method of claim 2, wherein the capturing is performed by processing the image to generate the captured product identification information as a product identifier; and wherein the identifying is performed by matching the product identifier with a reference product identifier.

4. The method of claim 1, wherein the capturing is performed by holding and aiming the interrogation device at the information associated with the product by the user to capture return light from the product as an image, and by processing the image to generate the captured authentication information and the captured product identification information as a single image pattern; and extracting the captured authentication information from the single image pattern, and distinguishing the captured authentication information from the captured product identification information.

5. The method of claim 1, wherein the sending is performed by sending the transactional information as promotional information from a product manager to the device.

6. The method of claim 1, wherein the sending is performed by sending the transactional information as customer buying and brand preference profile information to a product manager.

7. The method of claim 1, wherein the sending is performed by sending the transactional information as census information indicating quantities of counterfeit and genuine products.

8. The method of claim 1, wherein the sending is performed by sending one type of the transactional information when the product is genuine, and a different type of the transactional information when the product is counterfeit.

9. The method of claim 1, and identifying the device, and storing data about the device and the product to generate a marketing profile of the user, and reporting to a product manager whether the sending of the transactional information resulted in a sale of the product.

10. A system for authenticating and custom marketing a product, comprising:
an interrogation device operated by a user and operative for capturing authentication information and product identification information associated with the product;
an authentication server for authenticating the product from the captured authentication information as being genuine or counterfeit;
a marketing server for identifying the product from the captured product identification information, and for sending transactional information about the identified product in response to operation of the authentication server; and
a gateway server for directing the captured authentication information to the authentication server, and for directing the captured product identification information to the marketing server.

11. The system of claim 10, wherein the interrogation device is a portable device held by the user and has an imaging module for capturing return light from the product as an image, and for processing the image to generate the captured authentication information as an image pattern; and wherein the authentication server has a processing module for comparing the image pattern with a reference authentication signature, and for indicating that the product is genuine when the image pattern matches the reference authentication signature.

12. The system of claim 11, wherein the interrogation device is operative for processing the image to generate the captured product identification information as a product identifier; and wherein the marketing server is operative for matching the product identifier with a reference product identifier.

13. The system of claim 10, wherein the interrogation device is a portable device held by the user and has an imaging module for capturing return light from the product as an image, and for processing the image to generate the captured authentication information and the captured product identification information as a single image pattern; and wherein the gateway server has an extraction module for extracting the captured authentication information from the single image pattern, and for distinguishing the captured authentication information from the captured product identification information.

14. The system of claim 10, wherein the marketing server is operative for sending the transactional information as promotional information from a product manager to the device.

15. The system of claim 10, wherein the marketing server is operative for sending the transactional information as customer buying and brand preference profile information to a product manager.

16. The system of claim 10, wherein the authentication server is operative for sending the transactional information as census information indicating quantities of counterfeit and genuine products.

17. The system of claim 10, wherein the marketing server is operative for sending one type of the transactional information when the product is genuine, and a different type of the transactional information when the product is counterfeit.

18. The system of claim 10, wherein the marketing server is operative for identifying the device, and for storing data about the device and the product to generate a marketing profile of the user, and for reporting to a product manager whether the sending of the transactional information resulted in a sale of the product.

19. A system for authenticating and custom marketing a product, comprising:
an image capture device held by a user and operative for capturing return light from the product as an image, and for processing the image to generate captured authentication information and captured product identification information associated with the product;
an authentication server for determining that the product is genuine when the captured authentication information matches a reference authentication signature for the product, and for determining that the product is counterfeit when the captured authentication information does not match the reference authentication signature for the product;
a marketing server for identifying the product from the captured product identification information, and for sending one type of the transactional information about the identified product from a product manager to the device when the authentication server has determined that the identified product is genuine, and for sending a different type of the transactional information about the identified product from the product manager to the device when the authentication server has determined that the identified product is counterfeit; and
a gateway server having an extraction module for extracting the captured authentication information from the image, and for directing the captured authentication information to the authentication server, and for directing the captured product identification information to the marketing server.

20. The system of claim 19, wherein the gateway server has a registration module for registering the device.

21. The system of claim 19, wherein the marketing server has a user profile module for identifying the user, and a user buying behavior module for identifying the buying behavior of the user.

22. The system of claim 19, wherein the marketing server has an inference engine for offering other products related to the identified product to the device, and for sending promotional information about the other related products to the device.

23. The system of claim 19, wherein the marketing server has a report module for reporting to the product manager whether the sending of the transactional information resulted in a sale of the product.
